(19) United States
(12) Patent Application Publication
(10) Pub. No.: US 2006/0169213 A1
(43) Pub. Date: Aug. 3, 2006

(54) Birdbath with removable liner

(76) Inventors: Michael G. Montie, Magnolia, TX (US); Robbie A. Montie, Magnolia, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 10/999,623

(22) Filed: Jan. 31, 2005

(51) Int. Cl. A01K 45/00

(52) U.S. Cl. 119/69.5

(57) ABSTRACT

A birdbath is disclosed having one or more removable, replaceable liners for the In some embodiments, the liners are molded of thermoplastic material and nested on the base of the basin forming the birdbath. In use, the uppermost, soiled basin liner may be easily removed and discarded, exposing a fresh, clean basin liner ready for immediate filling with water. In certain embodiments, a retaining ring is provided for covering the rim and securing the basin liner to the basin. In yet other embodiments, the removable liners are equipped with a central aperture for accommodating a well in a raised, central portion of a basin that may be provided with a water pump, spray or drip.

### BACKGROUND OF THE INVENTION

1. Field of the Invention

This invention relates to birdbaths. More particularly, it relates to ornamental birdbaths commonly used in lawns and gardens to attract songbirds.

2. Description of the Related Art

Birdbaths have been used for many years to attract songbirds and other desirable bird species to lawn and garden areas. Bird feeders usually attract only seed-eating birds such as cardinals, blue jays and sparrows. Insect eaters and birds that feed on fruit—e.g., wrens, catbirds, waxwings—often ignore seed-containing feeders. But a birdbath is enticing to a wide variety of birds.

Pre-cast concrete is a commonly-used material especially for pedestal-type birdbaths. It generally has a neutral color, is inexpensive, weather-resistant, and its weight contributes to its stability in windy conditions. Moreover, birds seem to prefer its slightly rough surface texture which provides them a more secure foothold. In contrast, untreated metal and plastic birdbaths are often too slippery for birds to wade into securely.

It is generally thought that birdbaths should be shallow—no more than three inches deep at the center and even shallower at the edge so that birds can ease their way in. A spray or drip of water into the birdbath is believed to dramatically increase to number of species that will visit the birdbath. For example, hummingbirds generally will not wade into water but have been observed to fly through a drip of water, timing their flight so that they catch a drop of water on their backs on each pass.

However, a birdbath may comprise a pool of stagnant water, especially if not regularly maintained. Accordingly, algae and other organisms may grow in or around the water and debris may accumulate in the basin. Dirt and waste can make birds sick and birds need a ready supply of clean water in order to remain healthy. Cleaning a birdbath may be difficult inasmuch as most do not have drains and the rough surface of concrete birdbaths in particular may allow dirt and algae growth to adhere strongly. The present invention solves this problem.

### SUMMARY OF THE INVENTION

A birdbath having a removable, replaceable liner is disclosed. A plurality of liners may be nested in the basin of the birdbath such that removal of the topmost liner exposes the next (clean) liner in the stack. In one preferred embodiment, a locking ring covers the rim portion of the liners and provides a perching area around the periphery of the basin.

### BRIEF DESCRIPTION OF THE DRAWING FIGURES

FIG. 1 is an exploded, perspective view of a birdbath according to one embodiment of the invention.

FIG. 2A is a cross-sectional view taken along line 2-2 in FIG. 1.

FIGS. 2B and 2C depict the rim portions of alternative embodiments of the birdbath.

FIG. 2D shows the central portion of an alternative embodiment of the birdbath which has a central well or opening for a water feature.

FIG. 3 is a top plan view of the basin of the embodiment illustrated in FIG. 2A.

FIG. 4 is a top plan view of the basin of the embodiment illustrated in FIG. 2C.

### DETAILED DESCRIPTION OF THE INVENTION

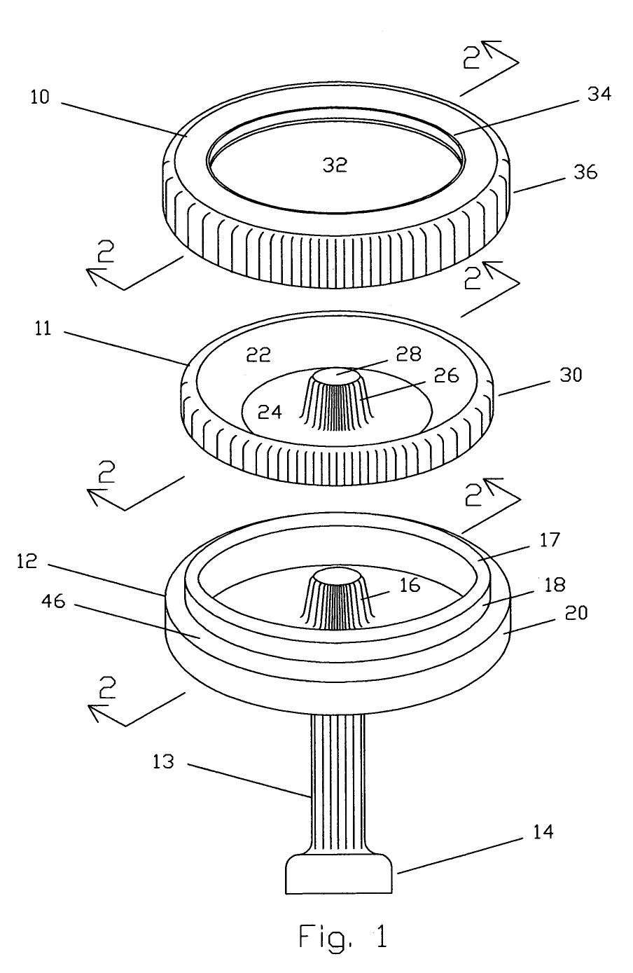

One, exemplary embodiment of the invention is shown in FIG. 1. The illustrated birdbath comprises basin 12 supported on pedestal 13 which terminates in base 14. Basin 12, pedestal 13 and base 14 may be formed of any easily-formed material. Weather-resistant materials are particularly preferred. Examples of such materials include pre-cast concrete, plastic resin, various metals or metal alloys and composite materials. Pedestal 13 may be detachable from basin 12 and/or base 14 so as to facilitate packaging and shipping the birdbath. Furthermore, individual pieces weigh less than the assembled birdbath which makes installation of the birdbath an easier task for homeowners.

In the illustrated embodiment, basin 12 comprises optional island 16, raised, circular shoulder 17 (having outer wall 18) and outer rim 20.

Liner 11 is sized to conform generally to the upper surface contours of basin 12 and may include sloped portion 22, flat portion 24 and central, elevated portion 26 which provides a generally flat perching area 28. In some embodiments, liner 11 may have sufficient structural rigidity to provide sloped area 22 and/or elevated portion 26 without corresponding structures in basin 12.

Liner 11 may be formed of any suitable material. Particularly preferred are thermoplastic polymers such as polyethylene, polypropylene, polyvinyl chloride, polystyrene, and the like, which may be readily molded into the desired shape and are sufficiently inexpensive to be disposable. Additional examples of suitable materials are coated papers, metal foils and composite materials.

As noted above, birds prefer birdbaths with at least a slightly rough surface texture which provides a non-slippery surface. This is particularly important for inclined portions of a birdbath such as sloped portion 22 of liner 11. Accordingly, selected portions (or all) of liner 11 may be provided with molded-in foothold-enhancing features such as ribs, dimples, protrusions, and the like. Alternatively, portions (or all) of the upper surface of liner 11 may be coated with a non-skid material which may incorporate granular substances.

The exemplary birdbath illustrated in the drawing figures also includes retaining ring 10 comprised of outer wall 36 and beveled, inner circumference 34 defining central opening 32. Ring 10 protects the edge(s) of liner(s) 11, secures liner(s) 11 to basin 12 and provides a decorative cover and perching area for the birdbath. In some embodiments, ring 10 may be equipped with a perch which may be attached to or molded to be integral with the exposed surface of ring 10. Such a perch may be generally circular in cross-section and sized to be readily grasped by desirable species of birds.

Ring 10 may be formed of any suitable material. For aesthetic reasons, ring 10 may be formed of the same material as that used for basin 12. Particularly preferred are moldable, thermoplastic materials.

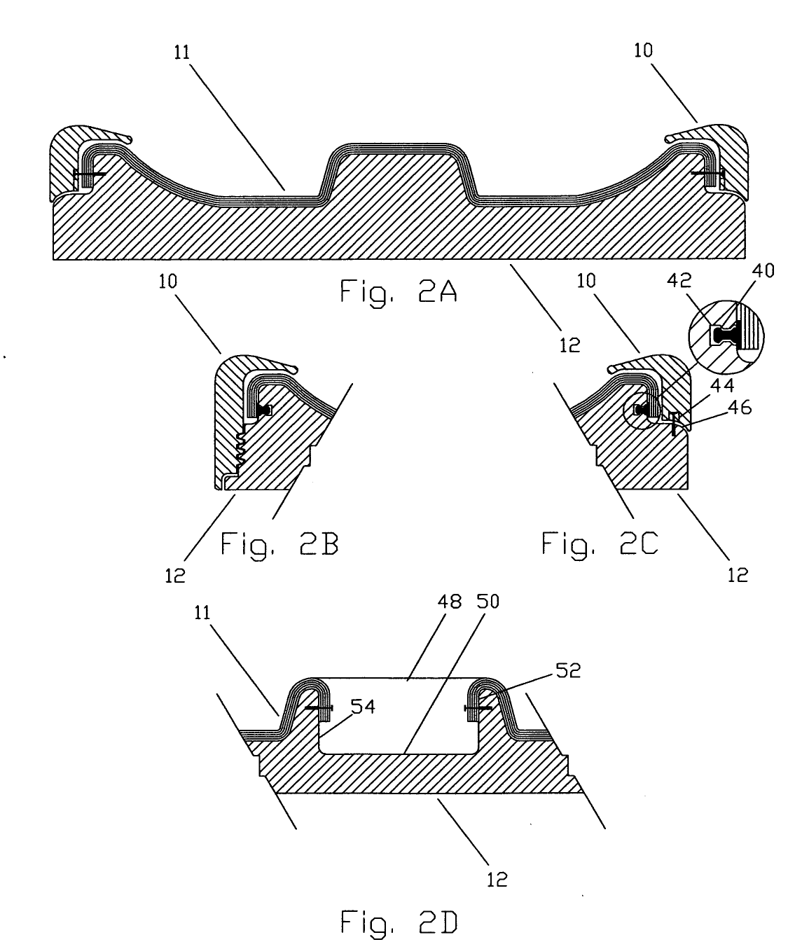

As may be best seen in the cross-sectional view of FIG. 2A, a birdbath according to the present invention may include a plurality of liners 11 in stacked or nested arrangement on the upper surface of basin 12. In this way, the soiled, uppermost liner 11 may be removed and discarded thereby exposing a fresh, new liner for containing the pool of water in the birdbath. The liners 11 may be progressively sized in order to facilitate stacking liners 11 in a nested arrangement.

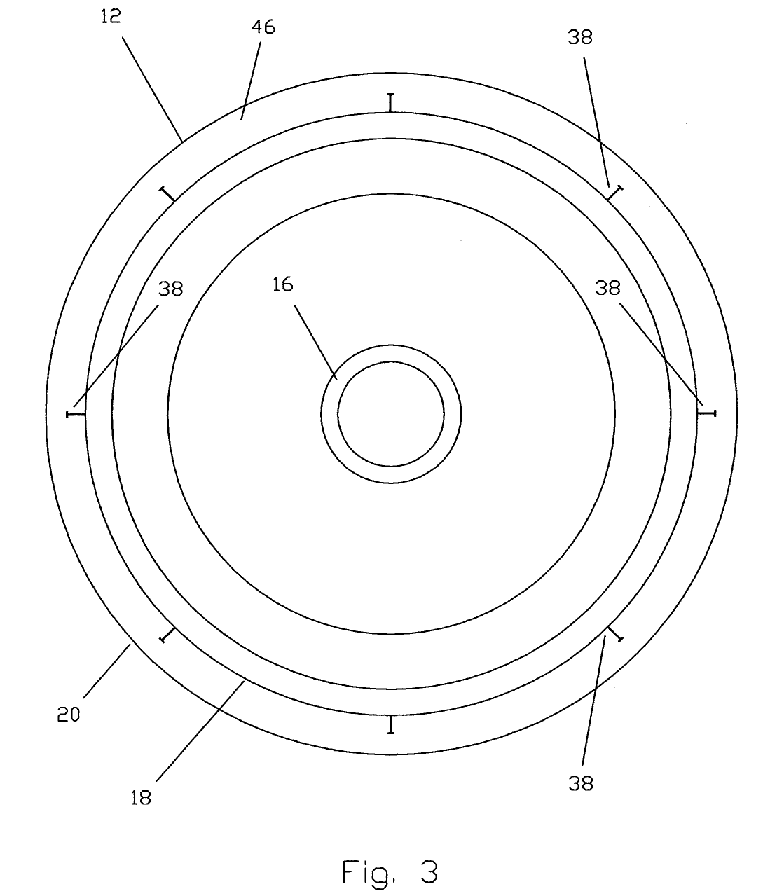

The embodiment shown in FIGS. 2A and 3 includes a plurality of T-headed studs 38 which may secure both liner(s) 11 and ring 10 to basin 12. The outer circumference or rim 30 of liner 11 may be provided with apertures through which studs 38 may pass. Studs 38 may have a threaded portion distal from the T-head portion which may engage a similarly threaded hole in the outer wall 18 of shoulder 17 of basin 12. The lower, inner circumference of ring 10 may be provided with L-shaped slots for engaging the T-head portion of the studs 38. As ring 10 is lowered onto basin 12, the T-heads of studs 38 may engage the leg of the L-shaped slots. As ring 10 is further lowered onto basin 12, the studs 38 will contact the horizontal portion of the L-shaped track, preventing further travel of ring 10 in the downward direction. At that point, the installer may rotate ring 10 such that the T-heads of studs 38 traverse the horizontal portion of the L-shaped tracks until they reach the terminus of the track at which point ring 10 is locked to basin 12 and liner(s) 11 are also secured to basin 12.

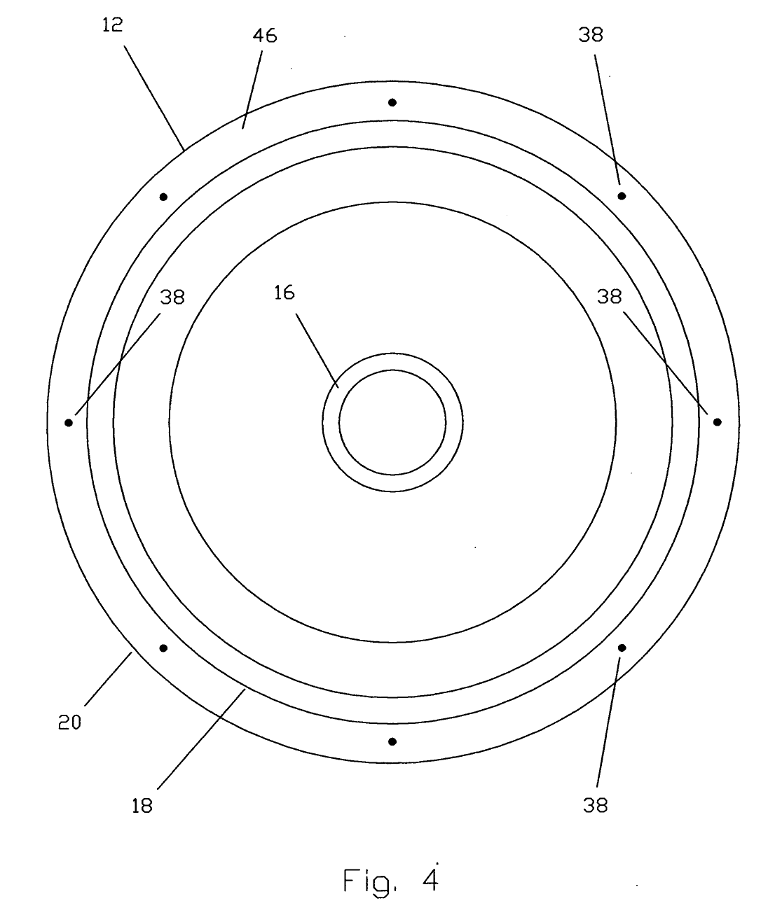

It will be appreciated by those skilled in the art that studs 38 may be positioned radially (as in FIG. 2A) but below the lower portion of rim 30 of liner(s) 11 or, vertically on perimeter shoulder 46 of basin 12 as illustrated in cross section in FIG. 2C and in plan view in FIG. 4. In such an embodiment, studs 38 need not be removable from basin 12 and liner(s) 11 need not have apertures in rim 30.

In the embodiment shown in FIG. 2C, retaining ring 10 may be equipped with keyhole-shaped slots 44 on its undersurface for engaging the heads of studs 38.

As may be best seen in the enlargement detail of FIG. 2C, innermost liner 11 may be equipped with a plurality of deformable projections 40 directed radially inward for snap-type engagement with corresponding receptacles 42 in the outer wall 18 of shoulder 17. The engagement of projections 40 with receptacles 42 secures liner(s) 11 to basin 12 and helps prevent the uplift of nested liner(s) 11 when the uppermost liner 11 is removed from the stack.

Still other embodiments of the present invention employ other means for securing ring 10 to basin 12. For example, as illustrated in FIG. 2B, the inner surface of ring wall 36 may be provided with threads and the outer rim 20 of basin 12 may have corresponding threads for engaging retaining ring 10. In such an embodiment, turning ring 10 in one direction engages it with basin 12 and turning it in the opposite direction disengages it. In still other embodiments, the inner surface of ring wall 36 may be provided with one or more protrusions or depressions for snap engagement with corresponding depressions/protrusions on outer rim 20 of basin 12. In other embodiments, magnets, hook-and-pile fasteners or mechanical fasteners may be used to secure ring 10 to basin 12. Depending on the material chosen, ring 10 may be of sufficient mass to rely solely on its weight to hold it in position on basin 12.

It will be appreciated that certain embodiments of the present invention may not employ a retaining ring 10, but may instead rely on the weight of the water in uppermost liner 11 to hold liner(s) 11 on basin 12.

The central portion of optional island 16 may be provided with a water pump for circulating the water, a water spout or a nozzle for providing a spray or drip of water into the birdbath. As shown in FIG. 2D, in such an embodiment, liner(s) 11 may be provided with an opening 48 in the center or plateau portion 28 of central elevation 26 for accommodating the pump, nozzle, spout or spray which may be located in or emerge from well 50 in basin 12. The interior rim 52 of liner 11 may also be secured to basin 12 with, for example, studs 38 which may be in threaded engagement with the interior surface of wall 54 forming well 50.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A birdbath comprising:
a substantially horizontal base forming a basin having an upper surface;
a removable liner on, and generally conforming to, the upper surface of the basin.

2. A birdbath as recited in claim 1 wherein the removable liner is formed from a polymer material.

3. A birdbath as recited in claim 1 further comprising a plurality of nested, removable liners.

4. A birdbath as recited in claim 1 wherein the removable liner comprises a raised central portion.

5. A birdbath as recited in claim 1 wherein the removable liner comprises a plurality of protrusions for increasing the traction of a bird's foot on the liner.

6. A birdbath as recited in claim 1 wherein the removable liner has a coating for increasing the traction of a bird's foot on the liner.

7. A birdbath comprising:
a substantially horizontal base forming a basin having an upper surface;
a removable liner on, and generally conforming to, the upper surface of the basin; and,
a ring in removable engagement with the base which covers the periphery of the removable liner.

8. A birdbath as recited in claim 7 further comprising a plurality of studs in threaded engagement with the base at the periphery of the basin and slots in the ring for engaging the studs.

9. A birdbath as recited in claim 7 further comprising threads on the base at the periphery of the basin for engaging corresponding threads on the inner circumference of the ring.

10. A birdbath as recited in claim 7 further comprising a plurality of nested, removable liners.

11. A birdbath as recited in claim 10 wherein the liners are formed of a polymer material.

12. A birdbath as recited in claim 11 wherein the liners comprise at least one textured portion.

13. A birdbath comprising:
a substantially horizontal base forming a basin having an upper surface;
a removable liner on, and generally conforming to, the upper surface of the basin and having a raised central portion with a central aperture there through; and,
a ring in removable engagement with the base which covers the periphery of the removable liner.

14. A birdbath as recited in claim 13 further comprising a plurality of studs in threaded engagement with the base at the periphery of the basin and slots in the ring for engaging the studs.

15. A birdbath as recited in claim 14 further comprising a plurality of apertures in the removable liner for engaging the studs.

16. A birdbath as recited in claim 14 further comprising a plurality of nested, removable liners.

17. A birdbath as recited in claim 16 wherein the liners are formed of a polymer material.

18. A birdbath as recited in claim 17 wherein the liners comprise at least one textured portion.

19. A birdbath as recited in claim 17 wherein the liners have at least one portion coated with an anti-slip material.

20. A birdbath as recited in claim 17 wherein the nested liners are progressively sized.
